(19) United States
(12) Patent Application Publication
(10) Pub. No.: US 2026/0318551 A1
(43) Pub. Date: Oct. 15, 2026

(54) ADAPTABLE FILTER FOR USE IN AN HVAC SYSTEM

(71) Applicant: Groove Technologies, LLC, Round Top, TX (US)

(72) Inventors: Fred MASSEY, Round Top, TX (US); Owen MASSEY, Round Top, TX (US)

(21) Appl. No.: 19/573,516

(22) Filed: Mar. 20, 2026

Related U.S. Application Data
(63) Continuation-in-part of application No. 18/677,098, filed on May 29, 2024.
Application No. 18/677,098 is a continuation-in-part of application No. 18/623,176, filed on Apr. 1, 2024.
Application No. 18/623,176 is a continuation-in-part of application No. 18/322,060, filed on May 23, 2023, now Pat. No. 11,945,286.

(51) Int. Cl. F24F 8/108; B01D 46/16

(52) U.S. Cl. CPC F24F 8/108; B01D 46/16; B01D 2275/203; B01D 2275/205; B01D 2279/50

(57) ABSTRACT

A filter that is adaptable for use in an HVAC system has a body formed in entirely of an air-transmissive open-cell polymeric material and a support surface affixed to a surface of the body. The support surface has a rigidity greater than the rigidity of the body. The body has a plurality of cuts extending entirely through thickness thereof. The plurality of cuts defining a plurality of cubical members frangibly connected together such that each of the plurality of cubical members is separable by hand from a remainder of the body such that an individual cubical member is removable along both a portion of a length and a portion of a width of the body. The support surface is honeycomb board. A plurality of tear strips extend across a length and a width of the support surface. A support surface has openings formed therein that correspond to the individual cubical members of the body.

### CROSS-REFERENCE TO RELATED APPLICATIONS

The present at application is a continuation-in-part of U.S. patent application Ser. No. 18/677,098, filed on May 29, 2024, presently pending. U.S. patent application Ser. No. 18/677,098 is a continuation-in-part of U.S. patent application Ser. No. 18/623,176, filed on Apr. 1, 2024, presently pending. U.S. patent application Ser. No. 18/623,176 is a continuation-in-part of U.S. patent application Ser. No. 18/322,060, filed on May 23, 2023, now U.S. Pat. No. 11,945,286, which issued on Apr. 2, 2024.

### FIELD OF THE INVENTION

The present invention relates to filters for HVAC systems. More particularly, the present invention relates to filters that reduce or remove dust, pollens, and hazardous contaminants. The present invention also relates to those filters that are used for the removal of odors, such as smoke, food and pet odors. More particularly, the present invention relates to air filters that are adaptable for installation into an HVAC system.

### BACKGROUND OF THE INVENTION

In conventional HVAC systems, it is desirable to purify the air that passes through the HVAC system. The purification of this air is carried out by suitable air filters. For example, purification of this air is carried out by suitable air filters that are positioned at an inlet of the HVAC system. Particle filters and odor-eliminating filters or their combinations are suitable for this purpose. The filter should remove or absorb as much as possible of suspended solids, particles and odors contained in the ambient air. Such filters for filtering air within HVAC systems are generally known in a variety of configurations.

An air filter for an HVAC system typically is a pleated-paper filter or fiber filter that is placed in an air intake or exhaust of the HVAC system. These air filters are uniquely shaped to fit within the available space within the HVAC system. This filter can greatly affect the effectiveness of the air conditioning and heating performance of the HVAC system. Clogged or dirty air filters can significantly reduce air flow through the HVAC system, as well as to allow allergens and contaminants to enter into the interior areas serviced by the HVAC's system. A drawback to conventional air filters in such HVAC systems is that, although many believe such air filters to be generally efficient, conventional filters for HVAC systems have a relatively low Minimum Efficiency Reporting Value (MERV). As such, typical air filters used in HVAC systems can allow the passage of airborne molecular contaminants and volatile organic compounds.

FIG. 1 shows a typical HVAC air filter 10 of the prior art. This typical air filter is formed of a paper material 12 that is folded into pleats and received within a frame 14. The size of the pleats and the distance between adjacent pleats are configured to maximize the filterability and air flow characteristics of the air filter 10. The frame 14 will have a particular size to fit within the HVAC system. Currently, HVAC systems have a wide variety of sizes. As such, it is important that the size of the frame 14, and the included pleated air filter 12, properly fit within the HVAC system so as to avoid air leakage therearound. As such, the air filter must be provided in a wide range of sizes.

FIG. 2 shows how the air filter 10 can be installed within the HVAC system 16. HVAC system 16 includes a fan 18 and a housing 20. The filter 10 will be interposed between the housing 12 and the fan 18. As such, the filter 10 can be in this position so that contaminants passing through the vents 22 of housing 20 can flow through the filter 12 and outwardly by way of the fan 18. Alternatively, if the fan 18 is directing air flow through the filter 10, the filter 10 prevents contaminants from passing outwardly through the vents 22 of the housing 20.

Unfortunately, this configuration of the air filter 10 has a large number of drawbacks. For the supplier of such air filters, a wide variety of sizes of such air filters must be maintained in stock. This creates large inventory problems for the supplier. The wide range of different sizes of the housing 20, or the interior of the HVAC system, necessitates that many different sizes of air filters remain in stock. Many times, an improperly-sized air filter is positioned within the HVAC system. An improperly-sized air filter will either not fit within the housing 12 or will improperly fit so as to allow air flow to pass therearound and remain unfiltered. The ability of such an air filter 10 to filter the air often depends upon the length of time in which the air filter remains within the housing 12 or within the HVAC system. Over time, the pores in the pleated paper material 12 become clogged and the filtering efficiency is reduced. Often, it can become so clogged that it ineffectively removes pollutants and reduces operating efficiency. As such, a need has developed so as to provide such an air filter which is adaptable to the wide variety of HVAC system sizes and shapes.

FIG. 3 is an illustration of the air filter that was proposed in prior U.S. patent application Ser. No. 18/677,098 by the present Applicant. In FIG. 3, the air filter 40 can have a wide variety of shapes and sizes. In particular, the air filter 40 includes a body 42 that is formed of an air-transmissive material. This air-transmissive material is an open-cell foam material. This open-cell foam material can be selected from among polyurethane, foamed polyether or foamed polyester (reticulated and non-reticulated). As can be seen, the body 42 has a generally rectangular configuration. In particular, the body has a top 44, a bottom 46, a pair of sides 48 and 50, a front 52 and a back 54. The body has a plurality of cuts 56 through the right thickness thereof. This thickness is defined between the top 44 and the bottom 46. The plurality of cuts 56 define a plurality of cubical members 58 that are frangibly connected together.

The plurality of cubical members 58 are frangibly connected to each other by a segment or a piece of the air-transmissive foam material. As such, the body 42 is held together in its generally rectangular configuration by the segments or pieces of the air-transmissive material.

The top 44 is in parallel planar relationship to the bottom 46. A pair of sides 48 and 50 are in parallel planar relationship to each other. The front 52 is in parallel planar relationship to the back 58.

In this embodiment of the earlier air filter of U.S. patent application Ser. No.18/677,098, as shown in FIG. 3, the body is adapted to be positioned within multiple sizes of an HVAC system. Initially, the body 42 has a length of approximately twenty-five inches and a width of twenty-five inches. The thickness of the body 42 is approximately one inch. This twenty-five inch by twenty-five inch by one inch configuration approximates the sizes of the maximum of most HVAC systems. In order to be installed with smaller HVAC systems, it is only necessary to remove the individual cubical members 58 along a column or a row of the body 42 until the remaining portion of the body 42 approximates the size of the housing or receptacle of the HVAC system.

The body 42 of the air filter 40 has no frame around the perimeter thereof, and no support surface on either the top or the bottom thereof. As such, there was no structure that could interfere with the ability to individually hand-remove the individual cubical members from the remainder of the body. To the extent that the body 42 is slightly larger than the housing to which it is to be placed, the filter 40 is easily compressible and flexible so that it can be “squeezed” into the area of the housing or receptacle of the HVAC system. If there would be a frame around the periphery of the body 42, this frame would need to be removed in order to properly separate the cubical members from the remainder of the body 42.

After experiments with this form of the present invention, it was found that the body 42 of the filter 40 had a very flimsy impression amongst users. The frangibly-connected cubical members would bend and deform as air filter 40 was being manipulated. As such, it presented a rather cheap and flimsy appearance to users. As such, a need to develop so as to be able to create a strong and durable appearance to the user, while at the same time allow for adaptability to the size of the HVAC system housing and to allow for proper air flow through the filter.

As can be seen, the air filter 40 includes the body 42 that is formed of the air-transmissive material. The body has a generally rectangular configuration with the top 44, the bottom 46, the pair of sides 48 and 50, the front 52 and the back. 54. The plurality of cuts 56 extend through the thickness of the body. This thickness is defined between the top 44 and the bottom 46. The plurality of cuts 56 define the plurality of cubical members 58 that are frangibly connected together. Each of the cubical members will generally be a one-inch cube.

The plurality of cubical members 58 are frangibly connected to each other by a segment or a piece of the air-transmissive foam material. As such, the body 42 is held together in its generally rectangular configuration by the segments or pieces of the air-transmissive material. Each of the plurality of cubical members 58 are separable by hand from the remainder of the body 42. Preferably, each of the plurality of cubical members 58 has sides of one-inch square area. For the purpose of fitting into the housing of a receptacle of the HVAC system, these one-inch sides of the cubical members will allow the user to easily determine the proper size of the filter 42 for insertion within the HVAC system. For example, if the size of the OEM filter is seven inches by nine inches, then each of the cubical members 58 to be removed until it achieves this proper size.

The configuration of this filter 40, as shown in FIG. 3 of the prior application by the present Applicant, is also applicable to fixed air-conditioning or heating systems, such as window unit air conditioners or heaters, mobile air purifiers and other systems that require an air filter. As such, the term “HVAC system” can include various varieties of stationary systems in industrial, commercial and residential use.

The body 42 can be shaped by removing the cubical members until the desired size is reached. Since the body 42 is a very large size, smaller HVAC systems can have several filters formed from a single body. 42. In terms of inventory, the use of the relatively large bodies 42 allows the bodies to be stacked one upon the other within a storage area. When a certain size of air filter is required, a user can take the body 42 and remove the cubical members 48 until the desired size is achieved. The remaining portion of the body 42 can be placed back into storage for future shaping. Since the body 42 has no frame around the periphery thereof, the shaping (by the separation of the cubical members 58 from adjacent cubical members) can be carried out in a quick and easy fashion.

The plurality of cuts 56 are achieved by cutting through the thickness of the body 42. In particular, there is a series of equally-spaced cuts formed lengthwise across the body and a series of equally-spaced cuts extending widthwise across the body. 42. In the course of this cutting, a small segment of material 60 can be retained such that the cubical members 56 are frangibly secured together. As such, only a small force, by hand, allows the cubical members 58 to be separated from a remainder of the body. 42. The step of cutting can be carried out by a knife, a slicer or a laser.

There are currently other types of replacement filters on the market. However, these require measuring and cutting with tools in order to replicate the existing filter. This technique is very time-consuming. It also has the intrinsic liability of causing injuries.

In the past, various patents and patent application publications have issued with respect to such filters. For example, an early patent is that of U.S. Pat. No. 5,192,346, issued on Mar. 9, 1993 to T. Kowalczyk. This patent teaches an air purifier pleated filter that stops pollution. This pleated filter is installed in the plenum the heating-cooling system. The filter is equipped with a sensor switch that notifies the user whenever the filter becomes dirty and must be replaced. The filter includes a hot fluid heater, such as a hot water heater, which protects the filter from freezing and keeps the filter dry which stops bacteria from multiplying and prevents odors.

U.S. Pat. No. 6,019,676, issued on Feb. 1, 2000 to S. Kim, provides an air filtration method and device to more effectively clean the ambient air via the existing OEM ventilation and heating/air conditioning system. The air is treated instantly as it is being discharged and the filter is compatible with existing OEM air filtration processes that are provided.

U.S. Pat. No. 7,083,514, published on Aug. 1, 2006 to Stamey, Jr. et al., provides an air-filtration system for delivering air to a helmet. The air-filtration system comprises an air intake in the form of a scoop for drawing exterior air, an air duct assembly for delivering air from the air intake to the helmet, and an air filter assembly disposed in-line with the air duct assembly between the air intake and the helmet. The air filter assembly includes a catalyst member for converting carbon monoxide to carbon dioxide and a particulate filter member.

U.S. Pat. No. 8,075,658, issued on Dec. 13, 2011 to Volkmer et al., provides a filter element that has a zigzag-shaped fold pack of folds. At least one terminal element is folded parallel to the folds of the fold pack. The terminal element has a first leg, a second leg, and a third leg. The first leg is arranged substantially perpendicular to a flow direction of a medium flowing through the filter element. The first, second and third legs are determined by folds in the terminal element. The first and second legs are positioned substantially at right angles relative to one another. The third leg projects laterally away from the filter element to form a peripheral seal.

U.S. Pat. No. 8,940,069, issued on Jan. 27, 2015 to D. Haider, shows an air filter that has a fold pack having a first side. A material with a first leg and a second leg is disposed on the first side. The first leg is attached to the first side and the second leg has a width that is greater than a height of the fold pack. The material strip forms at least partially a head band or a side band of the fold pack. A filter receptacle for the interior air filter has a slanted wall and a mounting and removal opening through which the interior air filter is inserted or removed. The slanted wall extends at an angle that corresponds to an angle defined by the second leg of the material strip of the air filter and a contact surface of the filter receptacle.

U.S. Pat. No. 9,687,769, issued on Jun. 27, 2017 to Mardall et al., provides an air filtration system that includes a HEPA filter for filtering air from an air inlet into filtered air. The HEPA filter includes a fine particulate filter and a gas filter. Air passageways are formed in the vehicle and configured to convey air from the air inlet to the HEPA filter and to convey the filtered air from the HEPA filter.

U.S. Pat. No. 9,964,078, issued on May 8, 2018 to Pham et al., teaches a filter assembly for an air cleaner that includes a main filter, an auxiliary filter set apart from the main filter, and a filter mount fixed to and supporting the main filter and the auxiliary filter. The filter mount is fillable into and removable from the housing of the air cleaner. The filter mount includes a sealing element passing between the main filter and the auxiliary filter.

U.S. Pat. No. 10,328,377, issued on Jun. 25, 2019 to I. Ferreira, shows a filter having a relatively rigid support frame having top and bottom frame members and side frame members. A filter element is disposed within and supported by the frame for filtering a medium passing through the filter element. A pair of opposing members of the frame are bendable into an arch so as to allow the filter to be progressively inserted along an arched path into a filter housing. Opposing sides of the frame are provided with V-shaped notches to facilitate bending the filter into an arch for insertion.

U.S. Patent Application Publication No. 2016/0280046, published on Sep. 29, 2016 to Williams et al., shows an air filter that comprises a supportive frame configured to suitably orient the air filter within an air filtration system. The supportive frame comprises a shape and size suitable for supporting the air filter within the ventilation system. A filter medium is retained within the supportive frame and is configured to remove the airborne molecular contaminants and volatile organic compounds from air flowing through the ventilation system. The filter medium electrostatically attracts and agglomerates contaminants within the air flowing through the air filter.

U.S. Patent Application Publication No. 2017/0001135, published on Jan. 5, 2017 to R. Paramore, describes an air filter that is constructed from a washable and reusable material. This air filter is capable of being positioned within an air-conditioning and heating system and is capable of being washed while substantially maintaining its original shape.

U.S. Patent Application Publication No. 2017/0368490, published on Dec. 28, 2017 to J. J. Wall, teaches a compound air filter provided for sequestering airborne contaminants from air streamed through the air filter. The air filter includes a support frame having a shape and size suitable for setting the air filter within the air filtering system. The compound air filter is retained within the support frame. A first media layer of the compound filter medium is pleated with pleats and configured to exhibit a relatively high filtration efficiency at a low air pressure drop across the filter medium. A second media layer of the filter medium is coupled to the first media layer and configured to maintain a uniform distribution of the pleats within the first media layer.

U.S. Patent Publication No. 2016/0296870, published on Oct. 13, 2016 to McKechnie describes a vent filter and appliance utilizing such a filter. The vent filter is user-replaceable once it is been spent or its filtration capacity consumed. The filter is provided in or as part of a cartridge that can be reversibly installed and removed from an appliance without tools. A retention structure is provided for holding the filter media in place in a filter receptacle communicating with or formed as part of the exhaust duct of the appliance for the air to be filtered. The filter is configured as a recirculating filter to remove odor-causing contaminants, among other contaminants, from cooking fumes before the air from those fumes is recirculated into the kitchen or other ambient environment.

It is another object of the present invention to provide a filter for an HVAC system that is easy to install.

It is another object of the present invention to provide a filter for an HVAC system that requires less inventory of the filter assemblies.

It is another object of the present invention to provide a filter for an HVAC system that filters the air very effectively.

It is another object of the present invention to provide a filter for an HVAC system that is adaptable to a wide variety of receptacles or housings within the HVAC system.

It is another object of the present invention to provide a filter for an HVAC system that is flame retardant.

It is another object of the present invention to provide a filter for an HVAC system that provides superior filtration.

It is another object of the present invention to provide a filter for an HVAC system that requires no tools for installation.

It is still another object of the present invention to provide a filter for an HVAC system that can be installed within the housing or receptacle of the HVAC system in a very quick and easy manner.

It is another object of the present invention to provide a filter for an HVAC system that is adaptable to the size of the HVAC system.

It is a further object of the present invention to provide a filter for an HVAC system has a requisite amount of rigidity during installation and use.

It is a further object of the present invention to provide a filter for an HVAC system that allows for even and clean tears when separating portions of the air filter.

It is still another object of the present invention to provide an air for filter for an HVAC system that allows even tears to occur while sizing the air filter to the HVAC system regardless of the orientation of the filter.

These and other objects and advantages of the present invention will become apparent from a reading of the attached specification and appended claims.

### SUMMARY OF THE INVENTION

The present invention is a filter that is adaptable for use in an HVAC system. This filter includes a body formed entirely of an air-transmissive open-cell polymeric material and a support surface affixed to a surface of the body. The body has a generally rectangular configuration. The body is a top, a bottom, a front, a back, and sides. The body is a plurality of cuts extending entirely through the thickness thereof from the top to the bottom. The plurality of cuts define a plurality of cubical members frangibly connected together such that each of the plurality of cubical members is separable by hand from a remainder of the body such that an individual cubical member of the plurality of cubical members is removable along both a portion of a length and a portion of a width of the body. The support surface is affixed to a surface of the body. This support surface has a rigidity greater than the rigidity of the body.

In the present invention, the support surface has a portion separable from the remainder of the support surface so as to expose a portion of the body at the surface of the body. This portion is a tear strip extending across a length or a width of the support surface. In particular, this portion includes a plurality of tear strips arranged in spaced parallel relation across the length of the support surface. This portion also can include at least another tear strip extending across the width of the support surface.

In the preferred embodiment of the present invention, the support surface is a honeycomb board. The support surface has a plurality of openings formed therethrough. These openings are adapted to allow air to pass therethrough and into the body. The plurality of openings of the support surface are aligned with respective cubical members of the body. Each of the plurality of cubical members has sides of one square inch. In the preferred embodiment, the body has a length of twenty-five inches and a width of twenty-five inches. The body is no frame around the perimeter thereof.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF DRAWINGS

FIG. 1 is an upper perspective view showing a prior art pleated air filter.

FIG. 2 is a perspective view showing the installation of the prior art air filter into an HVAC system.

FIG. 3 is an upper perspective view showing the air filter of the prior-filed U.S. patent application Ser. No. 18/677,098 by the present Applicant.

FIG. 4 is an end view showing the air filter of the present invention.

FIG. 5 is a plan view showing the support surface as used on the present invention.

FIG. 6 is an upper perspective view of the honeycomb board.

FIG. 7 is an upper perspective view showing the air filter of the present invention as having been removed from a larger portion of the air filter.

FIG. 8 is a perspective view showing the manner in which a portion of the air filter can be removed from remaining portion of the air filter.

### DETAILED DESCRIPTION OF THE INVENTION

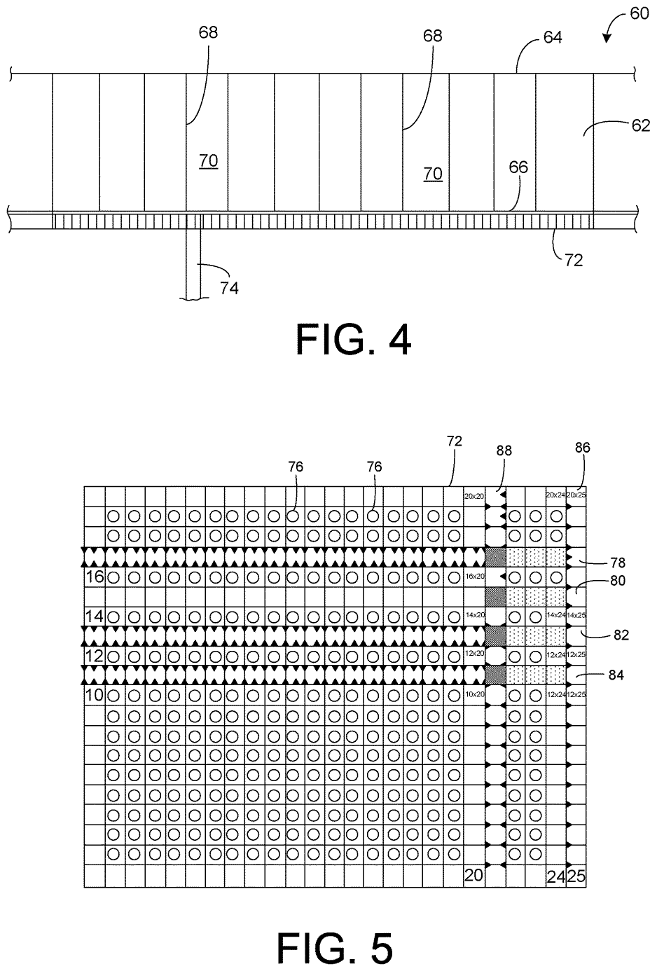

Referring to FIG. 4, there is shown an end view (or side view) of the air filter 60 in accordance with the teachings of the present invention. The air filter 60 includes a body 62 formed entirely of an air-transmissive open-cell polymeric material. This body 62 will have a generally rectangular configuration. The body has a top 64, a bottom 66, along with a front, a back and sides. The body 62 has a plurality of cuts 68 extending entirely through a thickness thereof from the top 64 to the bottom 66. The plurality of cuts 68 define the plurality of cubical members 70 that are frangibly connected together in the manner described hereinabove. Each of the plurality of cubicle members 70 is separable by hand from a remainder of the body 62 such that an individual cubical member 70 of the plurality of cubical members is removable along a portion of a length and a portion of the width of the body 62.

A unique feature of the present invention is the use of the support surface 72 that is affixed to a surface of the body 62. In particular, the support surface 72 will be affixed to the bottom 66 of the body. The support surface 72 will have a rigidity greater than the rigidity of the body 62.

The support surface 72 has a portion 74 that is separable from a remainder of the support surface 72. The removal of this portion 74 exposes a portion of the body 62 at the surface 66 of the body 62. In particular, this portion 74 is a tear strip that extends across a length or a width of the support surface 72. The support surface is a honeycomb board (in the manner to be described hereinafter).

FIG. 5 illustrates the support surface 72. It can be seen that the support surface 72 has a plurality of openings 76 formed therethrough. Each of the openings 76 will correspond with individual cubical members 70 of the body 62. Opening 76 allow air flow to pass therethrough. As such, when positioned in the HVAC system, air can flow through the air-transmissive open-cell polymeric material of the body 62 and outwardly through the opening 76 of the support surface 72.

Support surface 72 will have a size matching the size of the body 62. In the preferred embodiment of the present invention, the size of the body 62 will be approximately twenty-five inches by twenty-five inches. As such, support surface 72 will also have a size of twenty-five inches by twenty-five inches.

As can be seen, the support surface 72 has a plurality of tear strips 78, 80, 82 and 84, which extend in spaced parallel relationship across a length of the support surface 72. Tear strips 86 and 88 are configured to extend in spaced parallel relationship across the width of the support surface 72. During use, a particular tear strip amongst the tear strips 78, 80, 82, 84, 86 and 88 can be chosen so as to separate a portion of the support surface 72 and to expose the cut 68 between the individual cubical members 70 of the body 62. As such, the removal of one of the tear strips 78, 80, 82, 84, 86 and 88 can allow a user to selectively choose the size of the body 62 for removal from the remaining portion of the body. For example, if the desired size of the body 62 is twenty inches by twenty inches, then the tear strip 88 can be removed. As such, the frangible connection between the individual cubical members exposed by the removal of the tear strip 88 is exposed. As such, the user can easily separate the twenty inch by twenty inch portion of the air filter from the remaining portion. Similarly, if a sixteen inch by twenty inch air filter is desired, then tear strip 78 can be removed in the fashion described herein previously. It is only necessary to grasp an end of the particular tear strip, pull on the tear strip, and remove the tear strip so as to expose the frangibly-connected individual cubical members 70. The tear strips 78, 80, 82, 84, 86 and 88 are particularly configured so as to adapt to the various sizes of air intakes of HVAC systems.

An important aspect of the present invention is that the honeycomb board of the support surface 72 is particularly chosen because of its ability to allow the tear strips 78, 80, 82, 84, 86 and 88 to be removed with a clean and even tear regardless of the orientation of the support surface. Experiments were conducted using fluted support surfaces. It was found that the application of such tear strips to fluted support surfaces allowed for an even and clean tear in one direction, but created an uneven and jagged tear in an opposite direction. As such, such fluted support surfaces (in the nature of cardboard) were deemed to be inappropriate for the purposes of supporting the body 62 and for the purposes of allowing the proper sizing of the body to the particular HVAC system.

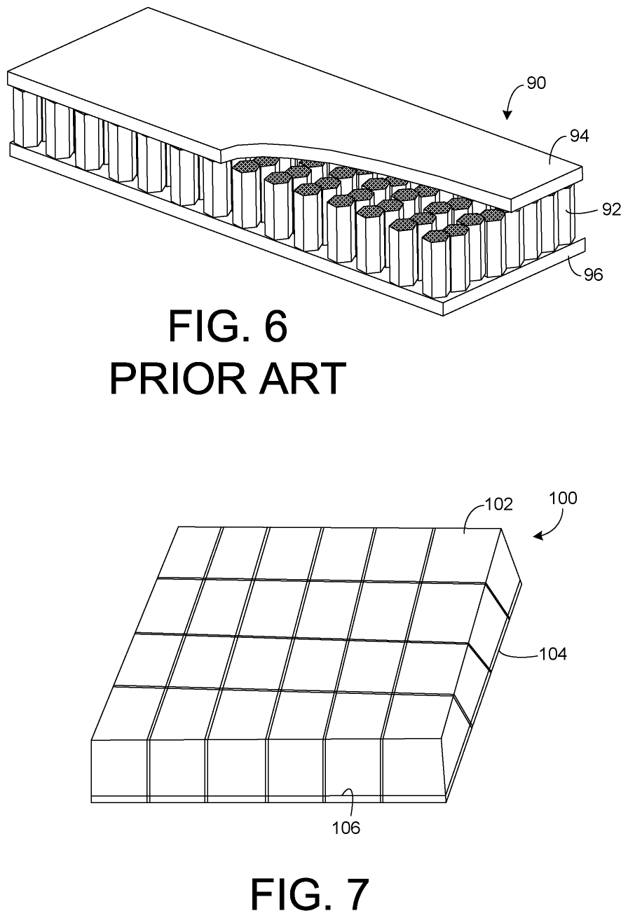

FIG. 6 is an illustration of such a honeycomb board 90 of the prior art. As can be seen, the honeycomb board 90 includes honeycomb interior 92 with a sheet 94 at one end of the honeycomb interior and another sheet 96 at an opposite and of the honeycomb interior 92. For the purposes of the present invention, the honeycomb board 90 can have a thickness of approximately ⅜ inch. As such, the tear strip can be applied to the honeycomb board 90 so as to tear entirely through the sheets 94 and 96 and the honeycomb interior 92. One of the sheets 94, 96 can be adhered to the bottom 66 of the body 62 of air filter 60. The unique configuration of the honeycomb interior will allow for an even tear by the tear strip regardless of the orientation of the honeycomb board 90 with respect to the body 62 of air filter 60.

FIG. 7 shows the air filter 100 as separated from the body 62 of air filter 62. As can be seen, the air filter 100 will have a length of six inches and a width of four inches (along with a thickness of one inch). As such, the individual cubical member 102 will be a one inch cube. The support surface 104 is illustrated as adhered to the bottom 106 of the body 102. As such, the air filter 100 will have a certain rigidity that avoids the flimsiness of the previous embodiment of the present invention. The support surface will allow airflow to pass freely therethrough because of the use of the various openings 76 formed on the support surface 104. It can be seen that the edges of the support surface 104 evidence a clean cut that is caused by the removal of the tear strip.

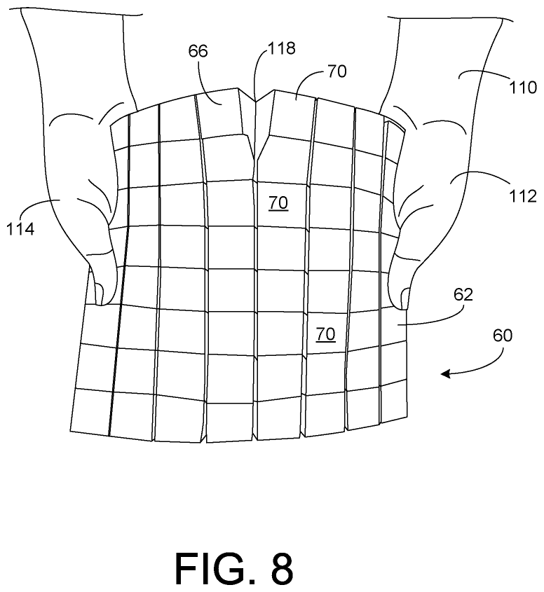

FIG. 8 illustrates the manner in which they air filter 60 can be properly sized into a smaller area by a user 110. In FIG. 8, it can be seen that the user 110 grasps the body 62 with his or her hands 112 and 114. The user's hands 112 and 114 act on the body 62 such that the cubical members 70 are separated from the cubical members 116. This will continue so that the cubical members along the line 118 continue to be separated from each other and such that an installable filter is thereby formed. The installable filter has a size and shape adapted to the fit the housing of a receptacle of the HVAC system. The remaining portion can be placed back into storage for future use or discarded. The polymeric foam material used for the manufacture of the body 62 is flexible and compressible. Ultimately, the installable filter should be no less than the size of the OEM filter. If it is slightly larger than the OEM filter, then it is easily compressible so as to fit within the receptacle or housing of the HVAC system. The support surface 72 that remains at the surface of the body 62 will further create an effective seal with the wall of the receptacle in the event that the installable filter is slightly less than the area of the receptacle. The compressibility of the air filter 60 allows the filter of the present invention to be properly retained without the need for a frame in order to establish a secure and tight fit within the receptacle or housing of the HVAC system.

Experiments with the polyurethane foam material of the body 62 of the filter 60 of the present invention has shown superior particulate retaining capabilities. The particles are removed from the airflow while, at the same time, the airflow through the air-conditioning system is not impeded to any substantial degree. As such, the present invention has a proper Minimum Efficiency Reporting Value (MERV). The configuration of the shaped filter achieved by the present invention prevents the passage of airborne molecular contaminants and volatile organic compounds. In tests conducted with the filter 40 of the present invention, it was found that the MERV value is 11. As reference, the American Society of Heating, Refrigerating and Air-Conditioning Engineers has come up with the MERV value to measure air filter performance. Under MERV, air filters are rated on a scale of 1 to 16 (with 17 to 20 reserved for true HEPA filters). The higher the rating, the more thoroughly an air filter can capture airborne particles as small as 0.3 m. For example, a MERV value of 1 to 4 will capture most types of dust, pollen and dust mites. A MERV value of 5-8 will capture most mold spores and pet dander. A MERV value of 9-12 will capture particles and Legionella bacteria. A MERV value 13 to 16 will capture all bacteria, most smoke, face powder and paint pigments. According to the in U.S. Environmental Protection Agency, filters with a MERV value of 7 to 12 are just as effective as true HEPA filters at removing most airborne particles.

It is important to keep in mind that a higher rating does not automatically mean better performance. As MERV values rise, the pores within the air filter shrink in size. This generates more resistance to air flow. This can cause an HVAC system that is not designed for that particular filter to work harder. Not only can this potentially damage the HVAC system, but it also degrades indoor air quality due to the reduction of airflow through the filter. For this reason, the National Air Filtration Association recommends filters rated at MERV 9 to 12 for residential systems. In the present case, the MERV value of 11 is achieved by the polyurethane foam material of the body 62 of the filter 60 and provides an optimum particle retaining capability while reducing strain and resistance on the HVAC system of the vehicle.

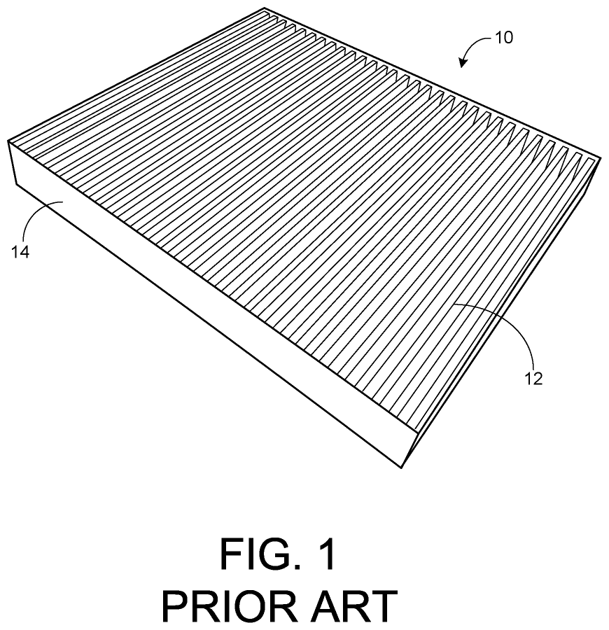

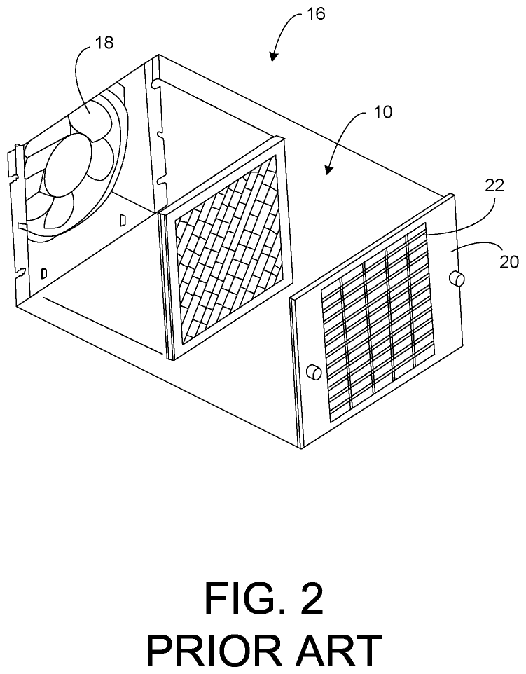

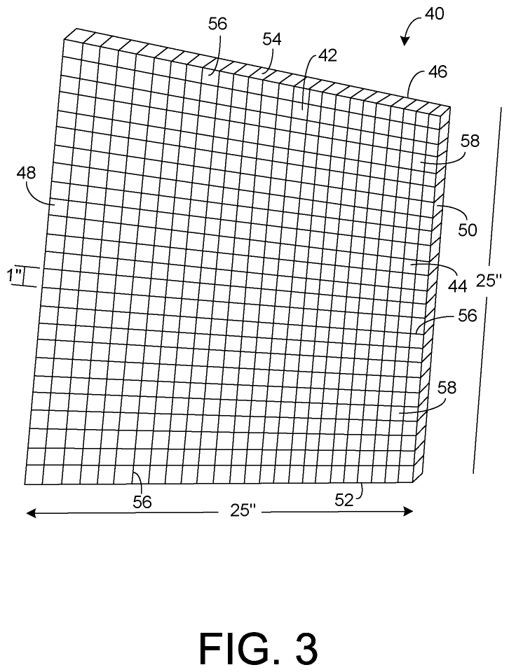

The filter 60 of the present invention greatly enhances the ability for suppliers to supply such air filters for a wide variety of vehicles. It is not necessary for the supplier to carry a wide variety and large number of sizes of such air filters. Since the present invention lacks the frame associated with existing pleated filters, the storage and shipment can be carried out in a relatively easy and efficient manner by simply compressing the filter and stacking the filters. When a particular size is required, all that is necessary is for the supplier to simply remove those cubical members from the body until the proper size is achieved. The present invention provides ease of installation by virtue of the fact that there are no tools required such as scissors, measuring devices, knives or other cutting devices. Since the filter of the present invention is compressible, minor variations in the size requirements and in the size provided by the supplier will not significantly impede the ability to supply the filter nor impede the ability for the filter to carry out its desired filtering operations. The filter of the present invention has a relatively long life when compared to the pleated paper filters of the prior art (as shown in FIG. 1). The filter of the present invention is relatively inexpensive. Since it is extremely easy to install, the cost associated with installation are significantly reduced.

The foregoing disclosure and description of the invention is illustrative and explanatory thereof. Various changes in the details of the illustrated construction can be made within the scope of the present invention without departing from the true spirit of the invention. The present invention should only be limited by the following claims and their legal equivalents.

1. A filter adaptable for use in an HVAC system, the filter comprising:
a body formed of an air-transmissive open-cell polymeric material, said body having a generally rectangular configuration, said body having a top and a bottom and a front and back and sides, said body having a plurality of cuts extending entirely through the thickness thereof from the top to the bottom, the plurality of cuts defining a plurality of cubical members frangibly connected together such that each of the plurality of cubical members is separable by hand from a remainder of said body such that an individual cubical member of the plurality of cubical members is removable along both a portion of a length and a portion of a width of said body; and
a support surface affixed to a surface of said body, said support surface having a rigidity greater than a rigidity of said body.

2. The filter of claim 1, wherein said support surface has a portion separable from a remainder of said support surface so as to expose a portion of said body at the surface of said body.

3. The filter of claim 2, wherein the portion is a tear strip extending across a length or a width of said support surface.

4. The filter of claim 3, wherein the portion comprises a plurality of tear strips arranged in spaced relation across the length of said support surface.

5. The filter claim 4, wherein the plurality of tear strips are in spaced parallel relationship to each other.

6. The filter of claim 4, wherein the portion comprises at least another tear strip extending across the width of said support surface.

7. The filter claim 1, wherein said support surface is a honeycomb board.

8. The filter of claim 1, wherein said support surface has a plurality of openings formed therethrough, the plurality of openings adapted to allow air to pass therethrough and into said body.

9. The filter of claim 8, wherein the plurality of openings of said support surface is aligned with respective cubical members of said body.

10. The filter claim 1, wherein each of the plurality of cubical members has sides of one square inch, wherein the body has a length of twenty-five inches and a width of twenty-five inches.

11. The filter of claim 1, wherein said body has no frame around the perimeter thereof.

12. A filter adaptable for use in an HVAC system, the filter comprising:
a body formed of an air-transmissive open-cell polymeric material, said body having a generally rectangular configuration, said body having a top and a bottom and a front and a back and sides, said body having a plurality of cuts extending entirely through a thickness thereof from the top to the bottom, the plurality of cuts defining a plurality of cubical members frangibly connected together such that each of the plurality of cubical members is separable by hand from a remainder of said body such that an individual cubical member of the plurality of cubical members is removable along both a portion of a length and a portion of the width of said body; and
a support surface affixed across a surface of said body, said support surface being formed of honeycomb board with a plurality of tear strips formed thereon, the plurality of tear strips extending across at least one of a length or a width of said support surface, at least one of the plurality of tear strips being separable from a remainder of said support surface so as to expose a portion of said body at the surface of said body.

13. The filter of claim 12, wherein said support surface has a rigidity greater than the rigidity of said body.

14. The filter of claim 12, wherein said support surface has a plurality of openings formed therein, the plurality of openings adapted to allow air to pass therethrough and into said body.

15. The filter of claim 14, wherein the plurality of openings of said support surface is aligned with respective cubical members of said body.

16. The filter of claim 12, wherein said body has no frame around the perimeter thereof.

17. A filter adaptable for use in an HVAC system, the filter comprising:
a body formed of an air-transmissive open-cell polymeric material, said body having a generally rectangular configuration, said body having a top and a bottom and a front and a back and sides, said body having a plurality of cuts extending entirely through a thickness thereof from the top to the bottom, the plurality of cuts defining the plurality of cubical members frangibly connected together such that each of the plurality of cubical members is separable by hand from a remainder of said body such that an individual cubical member of the plurality of cubical members is removable along both of a portion of a length and a portion of a width of said body; and
a support surface affixed across a surface of said body, said support surface having a rigidity greater than the rigidity of said body, said support surface having a portion separable from a remainder of said support surface so as to expose a portion of said body, said support surface having a plurality of openings formed therethrough, the plurality of openings corresponding to respective cubical members of the plurality of cubical members.

18. The filter of claim 17, wherein the support surface is honeycomb board.

19. The filter of claim 17, wherein the portion of said support surface that is separable for remainder of said support surface is a plurality of tear strips formed thereon, the plurality of tear strips being in spaced parallel relation and extending across at least one of a length and a width of said support surface.

20. The filter of claim 17, wherein the body has no frame extending around the perimeter thereof.
